(19) United States
(12) Patent Application Publication
(10) Pub. No.: US 2024/0387953 A1
(43) Pub. Date: Nov. 21, 2024

(54) BUSBAR INTERCONNECT FOR A BATTERY PACK

(71) Applicant: TE Connectivity Solutions GmbH, Schaffhausen (CH)

(72) Inventor: Evan Dawley, Troy, MI (US)

(21) Appl. No.: 18/663,244

(22) Filed: May 14, 2024

Related U.S. Application Data
(60) Provisional application No. 63/466,800, filed on May 16, 2023.

(51) Int. Cl. H01M 50/507; H01M 50/249; H01M 50/528; H01M 50/569

(52) U.S. Cl. CPC H01M 50/507; H01M 50/249; H01M 50/528; H01M 50/569

(57) ABSTRACT

A busbar interconnect for electrically connecting cell terminals of battery cells in a battery pack includes a matrix of busbars. Each busbar includes a first mating end for mating with the corresponding cell terminal of the corresponding battery cell and a second mating end for mating with the adjacent cell terminal of the adjacent corresponding battery cell. The busbars electrically connect the battery cells in the battery pack. The busbar interconnect includes a busbar carrier holding each of busbars in the matrix. The busbar carrier includes a molded body formed around each of the busbars holding relative positions of the busbars. The molded body includes frame members holding corresponding busbars. The frame members are structural foam elements.

### CROSS REFERENCE TO RELATED APPLICATIONS

This application claims the benefit of U.S. Application No. 63/466,800, filed 16 May 2023, the subject matter of which is herein incorporated by reference in its entirety.

### BACKGROUND OF THE INVENTION

The subject matter herein relates generally to battery packs, such as battery packs for electric vehicles.

Electric vehicles include a battery system including a battery pack having a large number of battery cells. A typical battery system requires a connectivity solution to transfer/distribute power between groups of battery cells and have provisions for sensing battery parameters like voltage and temperature. To transfer power, busbars (aluminum or copper) are usually welded to the cell terminals in serial and/or parallel electrical configuration. As electric vehicle applications proliferate, the overhead cost of components ($/kWh) is scrutinized and there is a desire to minimize costs, such as by minimizing the part count and part numbers. For battery systems of electric vehicles, the battery cell stack sizes are very large. Typically, assembly of the battery system requires many parts, which are individually assembled to the corresponding cell terminals, which is time consuming and adds cost to the assembly process. Some battery systems include an injection molded carrier for the busbars which connect the battery cells. However, as the size of battery packs increase, there are limits to the size of the injection molded carrier due to the molding process limitations. For example, the sub-component sizes are too large for conventional injection mold processes. In addition, cycle time requirements (i.e. takt time) must reduce in order to meet greater production volumes. A streamlining of processes wherever possible is greatly needed in order to reduce capital, tooling, and part piece cost and conversion cost. There is also a desire for sustainable processes and supply chain.

A need remains for a method for assembling battery packs, such as for electric vehicles, in a cost effective and reliable manner.

### BRIEF DESCRIPTION OF THE INVENTION

In one embodiment, a busbar interconnect for electrically connecting cell terminals of battery cells in a battery pack is provided. The busbar interconnect includes a plurality of busbars arranged in a matrix having multiple rows and multiple columns of the busbars. Each busbar includes a first mating end for mating with the corresponding cell terminal of the corresponding battery cell and a second mating end for mating with the adjacent cell terminal of the adjacent corresponding battery cell. The busbars electrically connect the battery cells in the battery pack. The busbar interconnect includes a busbar carrier holding each of busbars in the matrix. The busbar carrier includes a molded body formed around each of the busbars holding relative positions of the busbars. The molded body includes frame members holding corresponding busbars. The frame members are structural foam elements.

In another embodiment, a busbar interconnect for electrically connecting cell terminals of battery cells in a battery pack is provided. The busbar interconnect includes a plurality of busbars arranged in a matrix having multiple rows and multiple columns of the busbars. Each busbar includes a first mating end for mating with the corresponding cell terminal of the corresponding battery cell and a second mating end for mating with the adjacent cell terminal of the adjacent corresponding battery cell. The busbars electrically connect the battery cells in the battery pack. Each busbar includes a main body, a first mating pad extending from the main body to the first mating end, and a second mating pad extending from the main body to the second mating end. The busbar interconnect includes a busbar carrier holding each of busbars in the matrix. The busbar carrier includes a molded body formed around each of the busbars holding relative positions of the busbars. The molded body includes frame members holding corresponding busbars. The frame members are structural foam elements. The frame members include longitudinal elements and lateral elements interconnecting the longitudinal elements. The lateral elements of the frame members attached to the main bodies of the busbars to support each of the busbars in the corresponding column. The longitudinal elements are located in gaps between the rows of the busbars. The first and second mating pads are remote from the frame members and is freely movable relative to the frame members.

In a further embodiment, a battery pack is provided and includes battery cells arranged in a matrix having multiple rows and multiple columns of the battery cells. Each battery cell includes a first cell terminal and a second cell terminal. The battery pack includes a busbar interconnect for electrically connecting cell terminals of battery cells in a battery pack. The busbar interconnect includes a plurality of busbars and a busbar carrier holding each of the busbars in a matrix having multiple rows and multiple columns of the busbars. Each busbar includes a first mating end for mating with the first cell terminal of the corresponding battery cell and a second mating end for mating with the second cell terminal of the adjacent corresponding battery cell to electrically connect the battery cells in series. The busbar carrier includes frame members holding relative positions of the busbars. The frame members are structural foam elements.

### BRIEF DESCRIPTION OF THE DRAWINGS

FIG. 1 is a perspective view of a battery pack including a busbar interconnect in accordance with an exemplary embodiment.

FIG. 2 illustrates a matrix of the busbars in accordance with an exemplary embodiment.

FIG. 3 illustrates the busbar interconnect in accordance with an exemplary embodiment.

FIG. 4 is a cross sectional view of a portion of the busbar interconnect 200 in accordance with an exemplary embodiment taken along line A-A.

FIG. 5 is a cross sectional view of a portion of the busbar interconnect in accordance with an exemplary embodiment taken along line B-B.

FIG. 6 is a cross sectional view of a portion of the busbar interconnect in accordance with an exemplary embodiment taken along line C-C.

FIG. 7 illustrates a plurality of the busbar interconnects arranged in a stack.

FIG. 8 is an exploded view of the busbar interconnect in accordance with an exemplary embodiment.

FIG. 9 illustrates the busbar interconnect coupled to the battery pack in a first orientation.

FIG. 10 illustrates the busbar interconnect coupled to the battery pack in a second orientation.

FIG. 11 is a flow chart showing a method of assembling a battery pack in accordance with an exemplary embodiment.

### DETAILED DESCRIPTION OF THE INVENTION

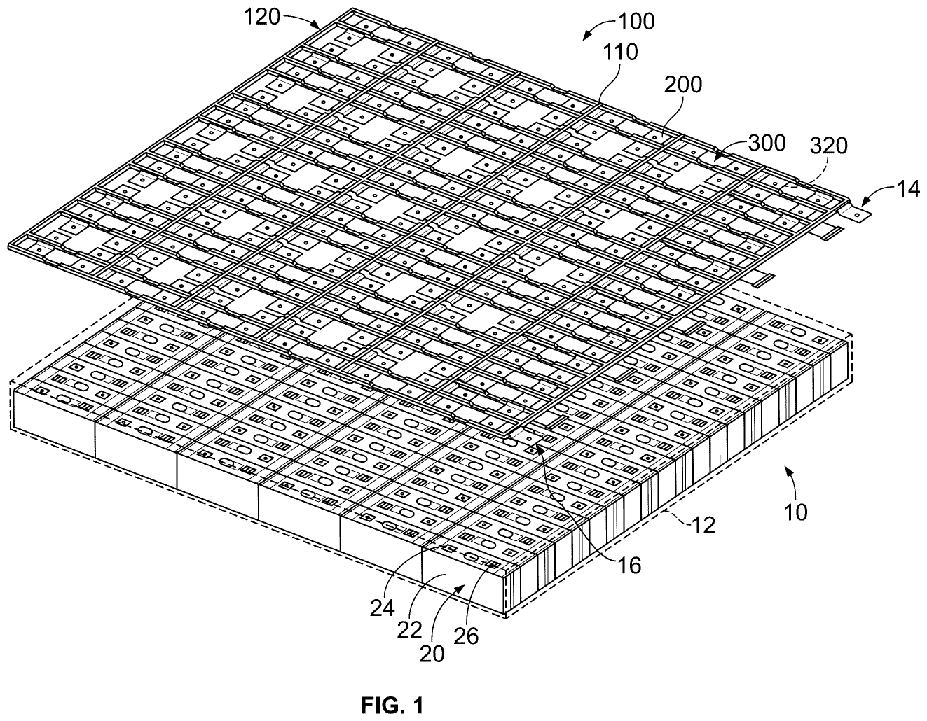

FIG. 1 is a perspective view of a battery pack 10 including a busbar interconnect 100 in accordance with an exemplary embodiment. The battery pack 10 may be a battery pack for a vehicle, such as an electric vehicle. However, the battery pack 10 may be used in other applications in alternative embodiments. In an exemplary embodiment, the battery pack 10 is a high voltage battery pack. For example, the battery pack 10 may be a 400V or 800V battery pack. The busbar interconnect 100 is used to electrically connect a matrix of battery cells 20 of the battery pack 10. For example, the busbar interconnect 100 may electrically connect the battery cells 20 in series and/or parallel.

The battery cells 20 may be held in a battery pack housing 12. The battery pack 10 includes a positive battery interconnect terminal 14 and a negative battery interconnect terminal 16. The battery interconnect terminals 14, 16 may interface to other power distribution components of the battery pack 10, such as contactors and fuses for connection to a charging system and/or a load, such as an electric motor.

Each battery cell 20 includes a cell housing 22, a first cell terminal 24, and a second cell terminal 26. The battery cell 20 may be a prismatic battery cell in various embodiments. The first and second cell terminals 24, 26 may be cathode and anode terminals. In an exemplary embodiment, the battery cell 20 are rectangular and arranged in a stacked configuration. For example, the battery cells 20 may be stacked in rows and columns of battery cells 20 in the matrix. The cell matrix may have a large surface area, such as greater than two square meters (2 m² or more). For example, the matrix may have a length of between approximately 1.0 m and 2.0 m and a width of between approximately 1.0 m and 1.5 m. Adjacent battery cells 20 in the rows are interconnected by the busbar interconnect 100. Adjacent rows of the battery cells 20 are interconnected by the busbar interconnect 100. For example, end battery cells 20 may be connected row-to-row.

The busbar interconnect 100 includes a busbar carrier 110 holding a plurality of busbars 200. The busbar carrier 110 holds the busbars 200 at relative locations for mating with the cell terminals 24, 26 of the corresponding battery cells 20. The busbars 200 electrically connect adjacent battery cells 20, such as in series and/or in parallel. The busbar carrier 110 integrates all of the busbars 200 into a single unit or structure for mounting to the matrix of battery cells 20. In an exemplary embodiment, the busbar carrier 110 is a structural foam leadframe that holds the busbars 200. The busbar carrier 110 is manufactured by a structural foam molding process. The busbar carrier 110 may be molded or formed on the busbar matrix. For example, the busbar carrier 110 may be overmolded in situ over portions of the busbars 200 to form the busbar interconnect 100. In an exemplary embodiment, the structural foam material forms a unitary, monolithic structure to hold all of the busbars 200. The busbar carrier 110 is formed around portions of the busbars 200 to hold the busbars 200 relative to each other and relative to the cell terminals 24, 26 of the battery cells 20. The structural foam is a cellular structure, such as a micro-cellular structure. In an exemplary embodiment, the structural foam has a low density micro-cellular core and a high density outer skin. The structural foam is rigid and retains its shape to hold the busbars 200 at relative positions for mounting to the battery cells 20. The busbar carrier 110 is made by a low-pressure structural foaming process. The busbar carrier 110 is manufactured from a polymer material, such as a thermoset or a thermoplastic with inert gas, such as nitrogen gas, injected into the mold during the forming process. The gas is co-injected with the resin material in the mold to foam the interior of the plastic. The lattice framework may be made with up to 100% regrind/recycled plastic material for environmental sustainability. A chemical blowing agent may be used to form the structural foam. The structural foam has a high strength-to-weight ratio, such as a higher strength to weight ratio compared to injection molded parts.

In an exemplary embodiment, the busbar carrier 110 is made from a single structural foam framework or lattice 120. The lattice 120 is formed around portions of the busbars 200 to hold the busbars 200 at relative positions. The lattice 120 is made from a mold, such as an aluminum mold. The structural foam material may be injection molded into the mold around the busbars 200. In an exemplary embodiment, the busbar carrier 110 holds all of the busbars 200 for the battery pack 10 to reduce part count for final assembly to the battery pack 10. For example, the single busbar interconnect 100 is assembled to the battery pack 10. The busbar carrier 110 is used to position all of the busbars 200 for electrical connection to the cell terminals 24, 26 of the battery cells 20. The structural foam busbar carrier 110 has excellent stiffness to weight ratio. In an exemplary embodiment, the structural foam busbar carrier 110 acts as a structural member in the battery pack 10 to resist torsion and z-displacement of the components of the battery pack, which improves safety and durability while eliminating the need for other mechanical components.

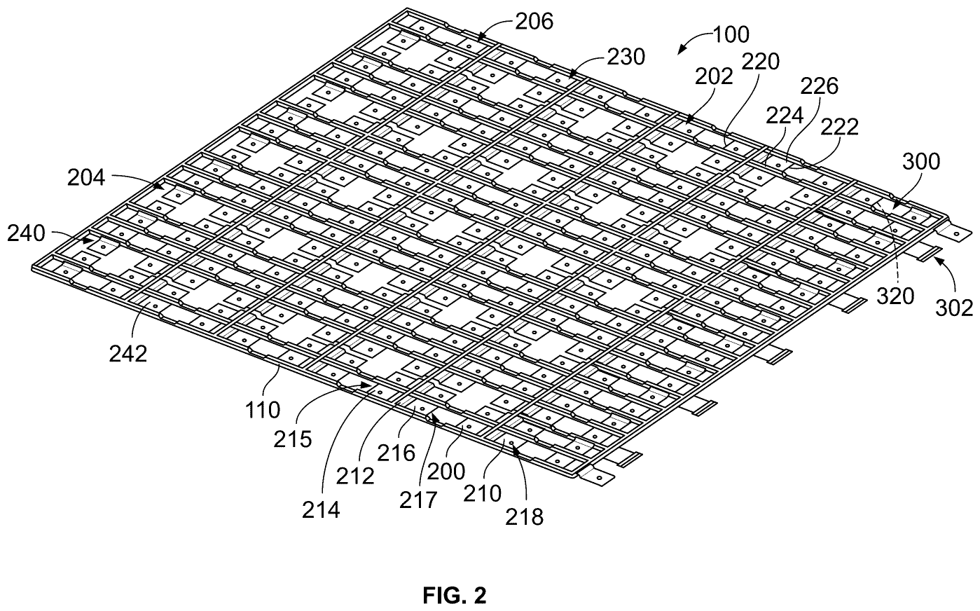

FIG. 2 illustrates a matrix 202 of the busbars 200 in accordance with an exemplary embodiment. The busbars 200 are arranged in rows 204 and columns 206 in the matrix 202. The arrangement of the busbars 200 corresponds to the arrangement of the battery cells 20 to connect to the corresponding cell terminals 24, 26.

Each busbar 200 includes a metal plate 210 having a main body 212, a first mating pad 214 at a first mating end 215, and a second mating pad 216 at a second mating end 217. The first mating pad 214 is configured to connect to a cell terminal 24 of one of the battery cells 20. The second mating pad 216 is configured to connect to a cell terminal 26 of an adjacent battery cell 20. The busbar 200 electrically connects the adjacent battery cells 20. The mating pads 214, 216 may include openings 218 therethrough, such as for locating the busbars 200 relative to the cell terminals 24, 26. The openings 218 may be used for a pick and place operation. The openings 218 may be used to hold positions of the busbars 200 during the overmolding process of forming the busbar carrier 110.

In an exemplary embodiment, each busbar 200 is generally rectangular. For example, the busbar 200 includes a first end 220, a second end 222, a first side 224, and a second side 226. The busbar 200 may be elongated, such as having the ends 220, 222 longer than the sides 224, 226. In an exemplary embodiment, the busbar is generally planar. For example, the first and second mating pads 214, 216 may be coplanar for attachment to the cell terminals 24, 26. Optionally, the main body 212 may be offset or out of plane relative to the first and second mating pads 214, 216, such as located above or below the plane of the first and second mating pads 214, 216. The busbar 200 may include mounting features, such as mounting tabs, posts, brackets, clips, notches, openings, and the like for mounting the busbar 200 to the busbar carrier 110.

In an exemplary embodiment, the busbars 200 are arranged in busbar strips 230. For example, a plurality of the busbars 200 may be stamped from a common sheet of material and arranged in strip format. In the illustrated embodiment, seven busbar strips 230 are provided. Greater or fewer busbar strips 230 may be provided in alternative embodiments. In various embodiments, twenty busbars 200 are provided in the busbar strips 230. Greater or fewer busbars 200 may be provided in each busbar strip 230 in alternative embodiments. Different busbar strips 230 may have different numbers of busbars 200. Optionally, connecting links may be stamped with the busbars 200 to connect the busbars 200 in the busbar strips 230. The connecting links mechanically fix the busbars 200 relative to each other, such as controlling a spacing between the busbars 200. The connecting links are thin strips. The connecting links are sacrificial and configured to be removed, such as by a stamping, punching, or cutting process to singulate and electrically isolate the busbars 200 from each other after the busbar carrier 110 is attached to the busbars 200.

In an exemplary embodiment, the busbars 200 include outer busbars 240 and inner busbars 242. The outer busbars 240 are arranged along the opposite sides of the busbar matrix 202 (for example, right side and left side). The outer busbars 240 are used to connect between two different rows of the battery cells 20. The inner busbars 242 extend between the outer busbars 240. The inner busbars 242 are used to connect the adjacent battery cells 20 within the same column. The outer busbars 240 are oriented perpendicular to the inner busbars 242. For example, the inner busbars 242 are oriented longitudinally and the outer busbars 240 are oriented laterally. Other orientations are possible in alternative embodiments. In the illustrated embodiment, five inner busbar strips 242 are arranged between the outer busbar strips 240. Greater or fewer numbers of the inner busbars 242 may be provided in alternative embodiments.

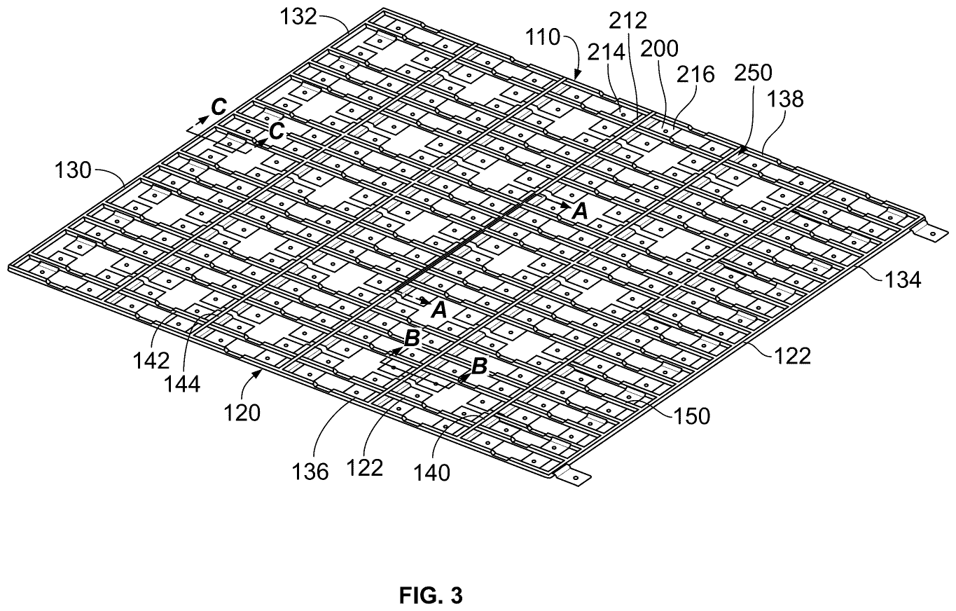

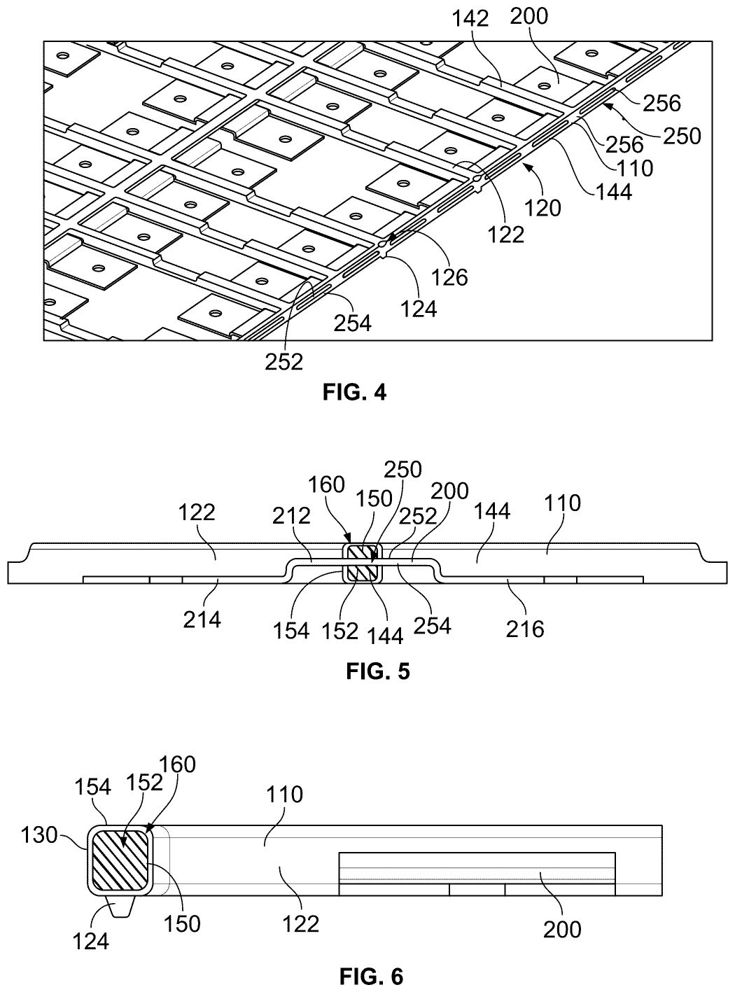

FIG. 3 illustrates the busbar interconnect 200 in accordance with an exemplary embodiment. FIG. 4 is a cross sectional view of a portion of the busbar interconnect 200 in accordance with an exemplary embodiment taken along line A-A. FIG. 5 is a cross sectional view of a portion of the busbar interconnect 200 in accordance with an exemplary embodiment taken along line B-B. FIG. 6 is a cross sectional view of a portion of the busbar interconnect 200 in accordance with an exemplary embodiment taken along line C-C.

The lattice 120 includes frame members 122 configured to be coupled to the busbars 200 to hold relative positions of the busbars 200. The frame members 122 are structural foam elements 150. The frame members 122 include outer frame members 130 surrounding a perimeter of the lattice 120 and inner frame members 140 spanning across an interior of the lattice 120 to interface with the busbars 200. In the illustrated embodiment, the outer frame members 130 completely enclose the perimeter. The outer frame members 130 include a first end member 132, a second end member 134, a first side member 136, and a second side member 138. The side members 136, 138 extend between the end members 132, 134. Optionally, the lattice 120 is elongated with the side members 136, 138 being longer than the end members 132, 134 in the longitudinal direction. The end members 132, 134 may be perpendicular to the side members 136, 138 in the lateral direction. Greater or fewer members may be provided in alternative embodiments to change the shape and the number of sides of the outer perimeter of the lattice 120.

The inner frame members 140 extend between the outer frame members 130. For example, the inner frame members 140 include longitudinal elements 142 and lateral elements 144. The longitudinal elements 142 extend longitudinally across the lattice 120 between the opposite end members 132, 134. The longitudinal elements 142 and/or the lateral elements 144 may be used to support portions of the busbars 200. The longitudinal elements 142 may be oriented generally parallel to the side member 136, 138. The lateral elements 144 extend laterally across the lattice 120 between the opposite side members 136, 138. The lateral elements 144 may be oriented generally parallel to the end members 132, 134. The lateral elements 144 interconnect the longitudinal elements 142, such as to provide support to the longitudinal elements 142, and vice versa. In an exemplary embodiment, the inner frame members 140 are formed integral with the outer frame members 130. For example, the inner frame members 140 are formed along with the outer frame members 130 during a structural foam molding process. The lattice 120 forms a unitary, monolithic structural foam structure.

Each frame member 122 includes the structural foam element 150. The structural foam element 150 is manufactured by a structural foaming process. The structural foam element 150 of the frame member 122 has a honeycomb-like microporous interior core structure. For example, each frame member 122 includes a foam core 152 (FIGS. 5 and 6) and a skin 154 (FIGS. 5 and 6) surrounding the foam core 152. The skin 154 has a higher density than the foam core 152. The foam core 152 include pockets or cells 156, which may be filled with air. The skin 154 may be solid, such as being devoid of air pockets. The skin 154 may be relatively thin, compared to the foam core 152.

In an exemplary embodiment, the lattice 120 includes alignment features 124 used to align the lattice 120 relative to the battery cells 20 in the battery pack 10. The alignment features 124 may include tabs, posts, protrusions, grooves, slots, openings, or other types of alignment features. The alignment features 124 may be used to align the lattice 120 with other lattice 120 for shipping or transport. For example, the alignment features 124 may interface with complementary alignment features 126 in order to nest or stack the busbar interconnects 100 on top of each other. For example, the alignment features 124 may be protrusions extending from the bottom and the alignment features 126 may be pockets formed in the top.

In an exemplary embodiment, the frame members 122 are manufactured by a structural foam molding process. The frame members 122 may be molded or formed in situ on the busbars 200. For example, the matrix of busbars 200 may be arranged in a mold and the frame members 122 may be overmolded over support portions of the busbars 200 to form the lattice 120. In an exemplary embodiment, the frame members 122 each include a molded body 160. The molded body 160 is formed by a molding process, such as an injection molding process. The molded body 160 is formed in place on the busbars 200. The structural foam molding material of the molded body 160 sets or cures to form the frame members 122. In an exemplary embodiment, the structural foam material forms a unitary, monolithic structure to hold all of the busbars 200. The busbar carrier 110 is formed around support portions of the busbars 200 to hold the busbars 200 relative to each other and relative to the cell terminals 24, 26 of the battery cells 20. The structural foam is a cellular structure, such as a micro-cellular structure. The frame members 122 are rigid and retain their shape to hold the busbars 200 at relative positions for mounting to the battery cells 20. The frame members 122 are made by a low-pressure structural foaming process. The frame members 122 are manufactured from a polymer material, such as a thermoset or a thermoplastic with inert gas, such as nitrogen gas, injected into the mold during the forming process. The gas is co-injected with the resin material in the mold to foam the interior of the plastic. The frame members 122 may be made with up to 100% regrind/recycled plastic material for environmental sustainability. A chemical blowing agent may be used to form the structural foam. The frame members 122 have a high strength-to-weight ratio, such as a higher strength to weight ratio compared to plastic injection molded parts.

In an exemplary embodiment, the busbars 200 include support sections 250 which are supported by the frame members 122. The frame members 122 are attached to the support sections 250 of the busbars 200. For example, the molded bodies 160 of the various frame members 122 are overmolded over the support sections 250 of the busbars 200. The molded bodies 160 encase or surround the corresponding support sections 250 of the busbars 200 in the corresponding frame members 122. For example, the molded body 160 may extend along an upper surface 252, a lower surface 254, and side edges 256 of the busbar 200 at the support section 250. The foam core 152 may interface with the surfaces 252, 254 and edges 256. In an exemplary embodiment, the support sections 250 are provided at the main bodies 212, such as along a central portion of the main bodies 212. The frame members 122 are attached to the main bodies 212 of the busbars 200 at the support sections 250, but the first and second mating pads 214, 216 are remote from the frame members 122. The first and second mating pads 214, 216 are freely movable relative to the frame members 122, such as for connection to the cell terminals 24, 26. The mating pads 214, 216 may be pressed against the cell terminals 24, 26 for laser welding (or other types of welding process, such as ultrasonic welding) to the cell terminals 24, 26.

In an exemplary embodiment, the lateral elements 144 span across the columns of busbars 200, such as along the main bodies 212 of the various busbars 200. The lateral elements 144 engage the busbars 200 to support the busbars 200. For example, the lateral elements 144 encase the support sections 250 of the busbars 200 to hold each of the busbars 200. The lateral elements 144 support each of the busbars 200 in the corresponding columns. In an exemplary embodiment, the longitudinal elements 142 are located in the gaps between the rows of the busbars 200. In the illustrated embodiment, the longitudinal elements 142 are not used to support the busbars 200. However, in alternative embodiments, the longitudinal elements 142 may additionally or alternatively be used to support some or all of the busbars 200.

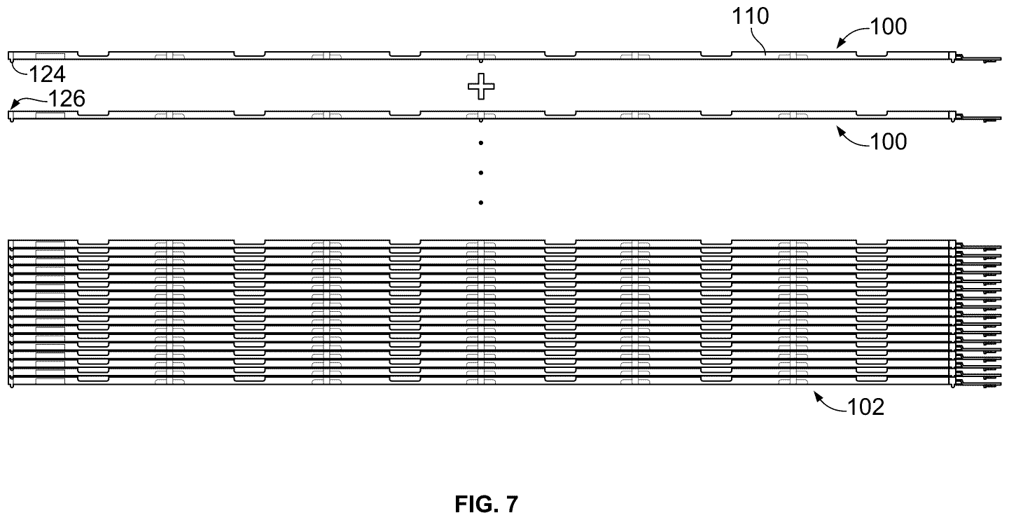

FIG. 7 illustrates a plurality of the busbar interconnects 100 arranged in a stack 102. The busbar interconnects 100 may be stacked for shipping or transport. In an exemplary embodiment, the busbar interconnects 100 may be self-stacking (i.e. nested) without the need for other packing material between the busbar interconnects 100. For example, the busbar carriers 110 hold the busbars 200. The busbar carriers 110 are rigid and self-supporting. The alignment features 124 interact with the alignment features 126 of other busbar carriers 110 in the stack 102 to align and position the busbar interconnects relative to each other. After stacked, bands or other holding features may be wrapped around the stack 102 to hold the busbar interconnects 100 in the stack 102.

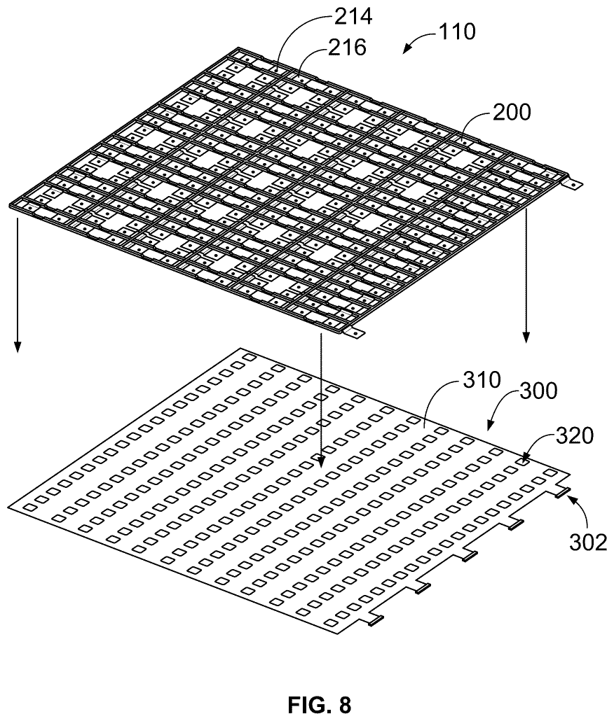

FIG. 8 is an exploded view of the busbar interconnect 100 in accordance with an exemplary embodiment. The busbar interconnect 100 includes the busbar carrier 110 and the matrix of busbars 200 held by the busbar carrier 110. In an exemplary embodiment, the busbar interconnect 100 includes a voltage and temperature sensing harness 300 having a plurality of sensing points 320 for monitoring the busbars 200 and/or the cell terminals 24, 26. For example, the sensing points 320 may be used to monitor voltage, temperature, charge state, or other operating characteristics of the busbars 200 and/or the cell terminals 24, 26. The sensing harness 300 is configured to be electrically connected to a control module, such as a battery control module. The sensing harness 300 sends sensing signals from the sensing points 320 to the control module, which may be used to control operation of the vehicle and/or a charging operation of the vehicle.

In an exemplary embodiment, the sensing harness 300 includes a sensor carrier 310 configured to carry a portion of the sensing circuit points 320 and circuits (i.e. traces). Optionally, a single sensor carrier 310 is provided carrying all of the sensing points 320. In an exemplary embodiment, a single sensing point 320 is provided for each busbar 200. In other various embodiments, a pair of sensing points 320 is provided for each busbar 200, such as for connection to both the first and second mating pads 214, 216 of each busbar 200. As such, each battery cell 20 may be monitored by multiple sensing points 320 for system redundancy. The sensing carrier 310 may be a flat flexible film. In various embodiments, the sensing harness 300 is a flexible circuit. In other various embodiments, the sensing harness 300 may be a wire harness having a plurality of wires extending from the various sensing points 320. The sensing harness 300 includes connectors 302 configured to be connected to the control module. The connectors 302 may be provided at one of more sides of the sensing harness 300. In the illustrated embodiment, all of the connectors 302 are provided at the same side. In other various embodiments, the sensing harness 300 may include a single connector 302 rather than multiple connectors 302.

The sensing harness 300 is configured to be coupled to the busbar carrier 110. For example, the sensing carrier 310 may be fixed to the busbar carrier 110, such as using adhesive, fasteners, clips, or other securing means. The sensing points 320 may be connected to the busbars 200, such as being connected by solder, welding, conductive adhesive, or other means to mechanically and/or electrically connect to the busbars 200. In other various embodiments, the sensing points 320 may be directly connected to the cell terminals 24, 26 in addition to or in the alternative to connection to the busbars 200.

The busbar interconnect 100 provides a large format battery cell interconnect that is configured to be mounted to the battery pack 10 (for example, each of the battery cells 20) as a single unit. The busbar carrier 110 holds all of the busbars 200 at proper locations for termination to the cell terminals 24, 26 of each of the battery cells 20 of the battery pack 10. By holding all of the busbars 200 for assembly to all of the battery cells 20 of the battery pack 10, assembly processes may be eliminated, such as with conventional battery systems where each of the busbars are assembled to the battery cells individually or in multiple strips with multiple assembly steps. The busbar interconnect 100 reduces the overall part number count and reduces the number of handled components during assembly of the battery pack 10. The busbar carrier 110 may have a large format and surface area. For example, the structural foam process to manufacture the lattice framework for the busbar carrier 110 enables a large footprint for the busbar carrier 110, particularly compared to injection molded parts. The busbar carrier 110 has a higher strength to weight ratio compared to comparable injection molded parts. The lattice framework supporting the busbar carrier 110 may be manufactured in a low-pressure, structural foam molding process, allowing use of lower cost molds (for example, aluminum molds compared to high-strength steel molds). The structural foam material of the lattice framework for the busbar carrier 110 is dimensionally stable and does not tend to warp making assembly and termination to the battery cells more simple, quicker, and lower cost compared to conventional assembly processes. The structural foam material is more sustainable to the environment compared to conventional injection molded plastic parts. For example, the structural foam material may use less plastic overall and may use recycled material.

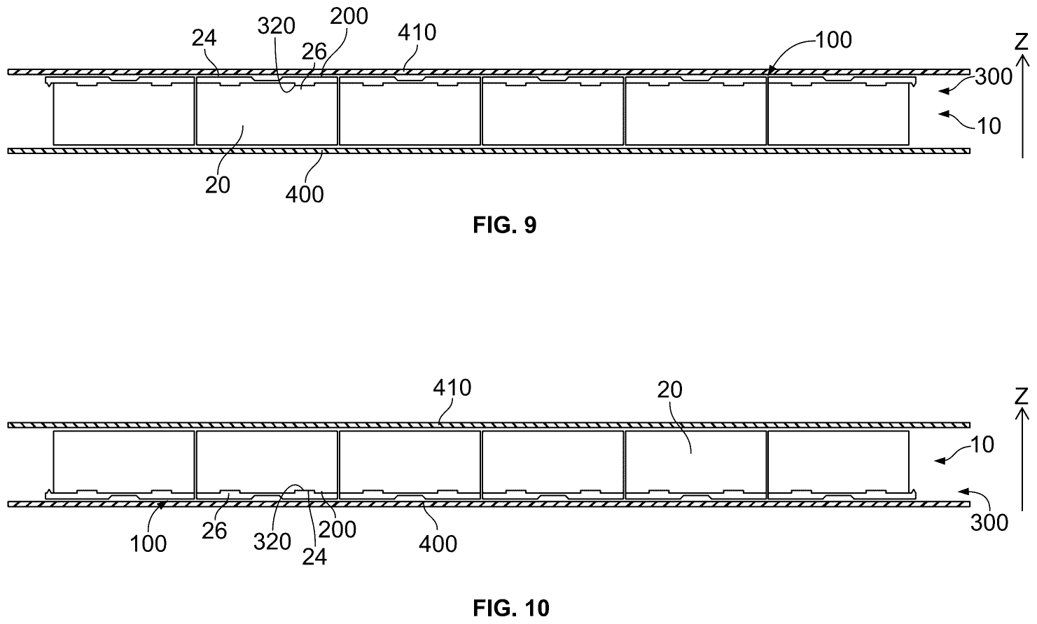

FIG. 9 illustrates the busbar interconnect 100 coupled to the battery pack 10 in a first orientation. FIG. 10 illustrates the busbar interconnect 100 coupled to the battery pack 10 in a second orientation. In the first orientation (FIG. 9) the busbar interconnect 100 is coupled to the top side of the battery pack 10. In the second orientation (FIG. 10), the battery pack is upside down, with the busbar interconnect 100 coupled to the bottom side of the battery pack 10.

In the first orientation (FIG. 9), the battery cells 20 are arranged with the cell terminals 24, 26 at the top (facing positive Z-direction) of the battery pack 10. The battery pack 10 is arranged in the vehicle on a tray or skid rail 400 of the vehicle. The busbar interconnect 100 is coupled to the top of the battery pack 10. The busbar carrier 110 holds the positions of the busbars 200, such as aligned with the corresponding cell terminals 24, 26. The busbars 200 are configured to be electrically connected to the cell terminals 24, 26. For example, the busbars 200 may be laser welded to the cell terminals 24, 26. The sensing harness 300 is coupled to the battery pack 10 with the busbar interconnect 100. The sensing points 320 are configured to be coupled to the cell terminals 24, 26 to monitor the battery cells 20. For example, the sensing points 320 may be laser welded to the cell terminals 24, 26. Optionally, the sensing points 320 may be laser welded to the cell terminals 24, 26 in the same step of laser welding the busbars 200 to the cell terminals 24, 26 to eliminate extra welding steps in the assembly process. In an exemplary embodiment, a pack cover and/or the vehicle floor 410 covers the battery pack 10 and the busbar interconnect 100. For example, the pack cover/vehicle floor 410 may be coupled to the top of the busbar interconnect 100. The pack cover/vehicle floor 410 may be bonded, adhered, or otherwise secured to the busbar carrier 110. The busbar carrier 110 may form a structural component of the vehicle and/or the battery pack 10, such as a structure used to support the pack cover/vehicle floor 410.

In the second orientation (FIG. 10), the battery cells 20 are arranged with the cell terminals 24, 26 at the bottom of the battery pack 10 (cell terminals facing the negative Z-direction). The busbar interconnect 100 is arranged in the space, such as along the tray/skid rail 400. The battery pack 10 is then lowered into position on the busbar interconnect 100. The bottom of the battery pack 10 is coupled to the top of the busbar interconnect 100. The busbar carrier 110 holds the positions of the busbars 200, such as aligned with the corresponding cell terminals 24, 26. The busbars 200 are configured to be electrically connected to the cell terminals 24, 26. For example, the busbars 200 may be laser welded to the cell terminals 24, 26. The sensing harness 300 is also coupled to the battery pack 10. The sensing points 320 are configured to be coupled to the cell terminals 24, 26 to monitor the battery cells 20. For example, the sensing points 320 may be laser welded to the cell terminals 24, 26. Optionally, the sensing points 320 may be laser welded to the cell terminals 24, 26 in the same step of laser welding the busbars 200 to the cell terminals 24, 26 to eliminate extra welding steps in the assembly process. In an exemplary embodiment, a pack cover and/or the vehicle floor 410 covers the battery pack 10. For example, the pack cover/vehicle floor 410 may be coupled to the top of the battery pack 10. The busbar carrier 110 may form a structural component of the vehicle and/or the battery pack 10, such as a structure used to support the battery cells 20 in the vehicle.

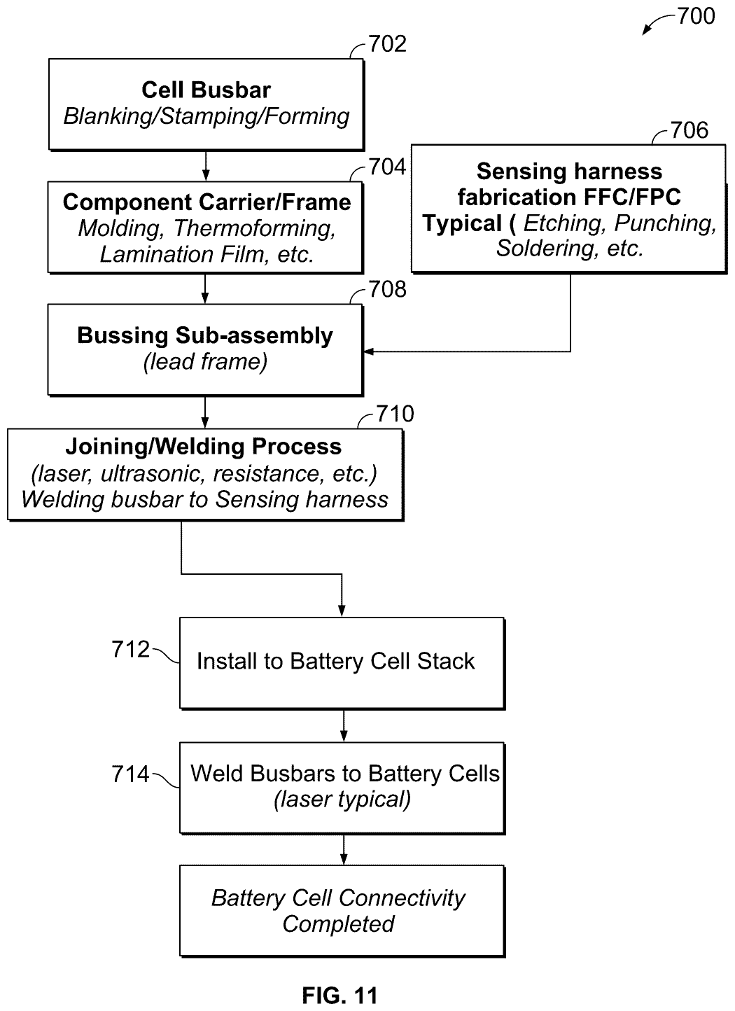

FIG. 11 is a flow chart 700 showing a method of assembling a battery pack in accordance with an exemplary embodiment. At 702, the method includes providing a matrix of busbars. The busbars may be formed by a stamping or laser cutting process. In an exemplary embodiment, the busbars are formed as busbar strips with connecting links between the various busbars, which are configured to be removed after the busbars are positioned in the matrix.

At 704, the method includes the step of structural foam molding a busbar carrier. The busbar carrier is coupled to the busbars. For example, the busbar carrier may be formed in place on the busbars. The busbar carrier may be overmolded over portions of the busbars to form a support frame for the matrix of busbars. The busbar carrier may be formed in a lattice of frame members. For example, the lattice of frame members may include longitudinal frame elements and lateral frame elements. The lattice of frame members may include outer frame members around an outer perimeter and inner frame members spanning across the middle of the outer frame members to form the lattice. The foam molding steps may be formed in a mold, such as an aluminum mold. The structural foam molding process includes forming a skin surrounding a foam core. The structural foam molding process includes adding inert gas, such as nitrogen, into a mold with thermoplastic or thermoset material. The structural foam molding process may include adding a chemical blowing agent into the mold with the thermoplastic or thermoset material.

At 706, the method includes the step of forming a sensing harness. The sensing harness includes a plurality of sensing points, such as for temperature sensors, voltage measurement, or other types of sensors. The sensing points are connected by circuits. The circuits may be flat flexible circuits, a flexible printed circuit, or a wire harness. At 708, the method includes the step of joining the sensing harness and the busbar carrier.

At 710, the method includes joining the sensing points to the busbars. For example, the sensors may be welded to the busbars. In other embodiments, the sensors may be coupled to the busbars by conductive adhesive or conductive epoxy. In alternative embodiments, the joining step may be eliminated and replaced by a later joining step simultaneously with joining the busbars to the cell terminals.

At 712, the method includes positioning the busbar interconnect at the battery pack. The busbar interconnect may be aligned with the battery pack, such as using locating features. The busbars of the busbar interconnect are aligned with the cell terminals of the battery cells. For example, the mating pads of each busbar are aligned with the cell terminals of adjacent battery cells to connect the battery cells in series or in parallel. The sensing points may be aligned with the battery cells.

At 714, the method includes joining the busbars to the battery cells. In an exemplary embodiment, the joining step includes laser welding the busbars to the corresponding cell terminals of the battery cells. The joining step may include joining the sensing points to the cell terminals, such as by laser welding, soldering, using conductive adhesive or otherwise connecting the sensing points to the cell terminals.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the invention without departing from its scope. Dimensions, types of materials, orientations of the various components, and the number and positions of the various components described herein are intended to define parameters of certain embodiments, and are by no means limiting and are merely exemplary embodiments. Many other embodiments and modifications within the spirit and scope of the claims will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. § 112 (f), unless and until such claim limitations expressly use the phrase “means for” followed by a statement of function void of further structure.

What is claimed is:

1. A busbar interconnect for electrically connecting cell terminals of battery cells in a battery pack, the busbar interconnect comprising:
a plurality of busbars arranged in a matrix having multiple rows and multiple columns of the busbars, each busbar including a first mating end for mating with the corresponding cell terminal of the corresponding battery cell and a second mating end for mating with the adjacent cell terminal of the adjacent corresponding battery cell, the busbars electrically connecting the battery cells in the battery pack; and
a busbar carrier holding each of the busbars in the matrix, the busbar carrier includes a molded body formed around each of the busbars holding relative positions of the busbars, the molded body including frame members holding corresponding busbars, the frame members being structural foam elements.

2. The busbar interconnect of claim 1, wherein the molded body is overmolded in situ over portions of the busbars to encase the portions of the busbars in the corresponding frame members.

3. The busbar interconnect of claim 1, wherein each busbar includes a support section supported by the corresponding frame member, the support section being encased in the mold body.

4. The busbar interconnect of claim 1, wherein the frame members have a honeycomb-like microporous interior core structure.

5. The busbar interconnect of claim 1, wherein each frame member includes a foam core and a solid skin surrounding the foam core.

6. The busbar interconnect of claim 5, wherein the skin has a higher density than the foam core.

7. The busbar interconnect of claim 1, wherein all of the frame members are an integral, unitary structure.

8. The busbar interconnect of claim 1, wherein each busbar includes a main body, a first mating pad extending from the main body to the first mating end, and a second mating pad extending from the main body to the second mating end, the frame members attached to the main bodies of the busbars, the first and second mating pads remote from the frame members and being freely movable relative to the frame members.

9. The busbar interconnect of claim 1, wherein the frame members have a higher strength to weight ratio compared to comparable plastic injection molded parts.

10. The busbar interconnect of claim 1, wherein the frame members include outer frame members surrounding a perimeter of the busbar carrier and inner frame members spanning across an interior of the busbar carrier to interface with the busbars.

11. The busbar interconnect of claim 10, wherein the inner frame members including longitudinal elements and lateral elements interconnecting the longitudinal elements.

12. The busbar interconnect of claim 11, wherein the rows of busbars and the columns of busbars are separated by gaps, the lateral elements supporting each of the busbars in the corresponding column, the longitudinal elements located in the gaps between the rows of the busbars.

13. The busbar interconnect of claim 1, further comprising a sensing harness having sensing points coupled to the busbars, the busbar carrier supporting the sensing harness.

14. A busbar interconnect for electrically connecting cell terminals of battery cells in a battery pack, the busbar interconnect comprising:
a plurality of busbars arranged in a matrix having multiple rows and multiple columns of the busbars, each busbar including a first mating end for mating with the corresponding cell terminal of the corresponding battery cell and a second mating end for mating with the adjacent cell terminal of the adjacent corresponding battery cell, the busbars electrically connecting the battery cells in the battery pack, each busbar includes a main body, a first mating pad extending from the main body to the first mating end, and a second mating pad extending from the main body to the second mating end; and
a busbar carrier holding each of busbars in the matrix, the busbar carrier includes a molded body formed around each of the busbars holding relative positions of the busbars, the molded body including frame members holding corresponding busbars, the frame members being structural foam elements, the frame members including longitudinal elements and lateral elements interconnecting the longitudinal elements, the lateral elements of the frame members attached to the main bodies of the busbars to support each of the busbars in the corresponding column, the longitudinal elements located in gaps between the rows of the busbars;
wherein the first and second mating pads are remote from the frame members and being freely movable relative to the frame members.

15. The busbar interconnect of claim 14, wherein the molded body is overmolded in situ over portions of the busbars to encase the portions of the busbars in the corresponding frame members.

16. The busbar interconnect of claim 14, wherein the frame members have a honeycomb-like microporous interior core structure.

17. The busbar interconnect of claim 14, wherein each frame member includes a foam core and a solid skin surrounding the foam core, the skin having a higher density than the foam core.

18. A battery pack comprising:
battery cells arranged in a matrix having multiple rows and multiple columns of the battery cells, each battery cell including a first cell terminal and a second cell terminal; and
a busbar interconnect for electrically connecting cell terminals of battery cells in a battery pack, the busbar interconnect including a plurality of busbars and a busbar carrier holding each of the busbars in a matrix having multiple rows and multiple columns of the busbars, each busbar including a first mating end for mating with the first cell terminal of the corresponding battery cell and a second mating end for mating with the second cell terminal of the adjacent corresponding battery cell to electrically connect the battery cells in series, the busbar carrier including frame members holding relative positions of the busbars, the frame members being structural foam elements.

19. The battery pack of claim 18, further comprising a sensing harness having sensing points coupled to the busbars, the busbar carrier supporting the sensing harness, the sensing points being electrically connected to the corresponding battery cells.

20. The battery pack of claim 18, wherein the molded body is overmolded over portions of the busbars to encase the portions of the busbars in the corresponding frame members.
